(19) United States
(12) Patent Application Publication
(10) Pub. No.: US 2007/0206005 A1
(43) Pub. Date: Sep. 6, 2007

(54) Method for generating 3D views or landscapes

(76) Inventor: Nicholas Phelps, Paris (FR)

Correspondence Address: FULBRIGHT & JAWORSKI, LLP, 666 FIFTH AVE, NEW YORK, NY, 10103-3198, US

(21) Appl. No.: 11/359,124

(22) Filed: Feb. 21, 2006

(51) Int. Cl. G06T 17/00

(52) U.S. Cl. 345/420

(57) ABSTRACT

A method for generating 3D landscapes which comprises the steps of selecting a plurality of 3D elements from a library of vegetative elements and distributing the 3D elements. The method either distributes the 3D elements on a terrain so that parameters of the 3D elements depend on an environment of the 3D elements or with a variable distribution density such that the parameters of the 3D elements depend on the variable distribution density. The parameters comprises the nature of the 3D elements, distribution density of the 3D elements, and their size, orientation, color and shape. The environment comprises an altitude of the terrain, a slope of the terrain, a position of the 3D elements relative to objects or other 3D elements on the terrain.

### FIELD OF INVENTION

The invention relates to a method for producing three dimensional (3D) or relief views.

### RELATED ART

The Applicant produces and distributes a software product called “Vue d'Esprit 4” for easily and automatically producing 3D views, particularly interior and exterior landscapes. This software product is a creation tool used by both amateurs and professionals, particularly architects, landscape designers, graphic artists or creators of synthetic images, particularly for cinema and television.

In this software product, the user has an interface that allows him to modify the color, texture, transparency or reflectivity of a terrain as a function of various parameters linked to this terrain such as altitude, slope or orientation. To this end, the known software product includes a function editor that makes it possible to associate a value, for example between 0 and 1, with any point in the space. For example, it is possible to indicate a transparency value that depends on the position within the material generated by the software product.

Modifications in the appearance can also be made using filters provided by a filter editor. These filters make it possible to modify profiles. A filter makes it possible to transform any number, for example in the range from 0 to 1, into another number, also in the range from 0 to 1, on a curve that can be defined by the user.

The filters can be influenced by the environment in order to improve the realism of the synthetic image. For example, a value between 0 and 1 indicates the importance of the effect of the slope. If the value is 0, the slope has no influence, and the influence of the slope increases as the value increases. When the value is equal to 1, no matter what the profile, the filter will supply the value 0 when the surface is horizontal and will return to 1 when the surface is vertical.

### OBJECT AND SUMMARY OF THE INVENTION

The present invention results from the observation that the realism of the synthetic 3D images of the Applicant's software product can be further improved by vegetation, or in general, by 3D elements on a terrain. It should be noted here that “terrain” is understood to mean not only an exterior landscape, but any type of 3D representation, for example a building or an interior landscape.

In accordance with an embodiment of the present invention, the method for generating 3D landscapes comprises: selecting one or more 3D element(s) from a library of elements, particularly a library of plants or trees, and distributing the 3D elements on the terrain so that the parameters of these 3D elements depend on their environment. The parameters can include at least one following: the position of the terrain, altitude of the terrain, slope of the terrain, orientation of the terrain, and the distance from objects or other 3D elements. In accordance with an aspect of the present invention, these parameters can be included in a group comprising: the nature and distribution density of the 3D elements, the size of these elements, their orientation, their color and their shape.

The present invention can be used not only for the generation or creation of images per se, but also for other applications such as the simulation and generation of environments, for example for computer games.

A 3D element may include 2D elements, the third dimension being represented by the position of the 2D elements.

The term 3D element is understood to mean elements that can be distributed on a terrain. This term covers not only vegetation but also, for example, buildings, people, animals, objects, rocks, vehicles, etc.

Thus, the present invention enables the generation of 3D landscapes that are very similar to reality. For example, the size and the color can vary with the altitude. For another example, the orientation of the elements, particularly vegetation, can vary with the slope of the terrain.

In accordance with an embodiment of the present invention, the variation of the parameters of the 3D elements as a function of the environment is continuous. In accordance with an aspect of the present invention, at least some of the parameters vary in terms of average value to increase realism, these parameters having a random value with a pre-selected variance.

In accordance with an embodiment of the present invention, the method comprises a step in which the density of the 3D elements, particularly the vegetation, is varied based on the position on the terrain, preferably independently from the altitude. Under these conditions, using density variation profiles, the present invention can generate as many solid shapes as desired. For example, the present invention can generate swaths of 3D elements with a profile based on an axis whose rectangular shape varies. Likewise, the present invention can vary all of the parameters in a nonlinear or discontinuous fashion.

The orientation of the elements is such that, for example, it is always vertical. In accordance with an aspect of the present invention, the orientation of the elements is normal to the surface of the terrain. In accordance with another aspect of the present invention, the orientation of the elements is random but is limited between two predetermined directions, for example between the vertical and the normal to the terrain. The present invention can assign any orientation, for example a constant orientation, between two predetermined directions such as the vertical and the normal to the terrain.

The orientation of each element also includes the orientation of each element relative to an axis; for example in the case of a plant, the present invention can choose the axis of the stalk or trunk. In accordance with an embodiment of the present invention, this orientation is random relative to the axis of the element. Under these conditions, the landscape gives an impression of great diversity.

In addition to the aforementioned advantages, it should be noted that the software product according to the present invention is compatible with the known software product. In particular, the functions or filters that make it possible to determine the parameters of the elements as a function of altitude, slope or orientation can be the same as the functions used in the known software to vary the color, texture, reflectivity and transparency of the terrain. In other words, the compatibility of the software product according to the present invention with the prior software product applies to the user interfaces.

In accordance with an embodiment of the present invention, the software product comprises modules or functions for varying colors, these functions can be applied to 3D elements such as vegetative elements. Thus, in accordance with an embodiment of the present invention, the software product comprises a module or means for varying the color of each element. For example, the color of the plants can be varied as a function of the characteristics of the terrain. Also, the present invention can modulate the color as a function of the density of the elements on the terrain; thus, in the case of plants, a lighter color can be assigned to the plants located on terrains that are more favorable to plants.

In accordance with an embodiment of the present invention, the functions of the prior software product for mixing materials can be also used. For example, the software product of the present invention comprises a module or means for generating stone at high altitudes and vegetation at lower altitudes.

In accordance with an embodiment of the present invention, the software product makes can mix materials.

The software product in accordance with an embodiment of the present invention comprises new rules for the coexistence of 3D elements and foreign elements (or 3D elements of different natures), thereby accommodating the specificity of the coexisting elements. Thus, the software product of the present invention comprises a module or means for reducing (or increasing) the density of the 3D elements in proximity to a foreign body, simulating, for example, an environment that is unfavorable (or favorable) to the 3D elements. For example, the 3D elements can be plants and the foreign body can be a rock. For another example, the 3D elements can represent a type of animal and the unfavorable environment can represent hostile animals. Moreover, in accordance with an aspect of the present invention, the software product can vary at least one of the following: the color, size, orientation in proximity to the environment that is unfavorable to the 3D elements. For example, in the case of vegetation, around this unfavorable environment, the vegetation will be more yellow and smaller in size.

Thus, in accordance with an embodiment of the present invention, a method for generating 3D landscapes comprises the step of selecting one or more 3D elements from a library of such elements, particularly a library of vegetative elements such as plants or trees. The present method additionally comprises the step of distributing the 3D elements on a terrain so that the parameters of these elements depend on their environment, particularly at least one of the following: the position of the terrain, the altitude of the terrain, the slope of the terrain, the position of the elements relative to objects or other 3D elements on the terrain. These parameters being included in a group comprising: the nature of the elements, the distribution density of the 3D elements, their size, their orientation, their color and their shape. Alternatively, the present method additionally comprises the step of distributing the 3D elements on a terrain with a variable distribution density, and making parameters of the 3D elements depend on this density. These parameters being included in the group comprising: the nature of the elements, their orientation, their color and their shape.

In accordance with an embodiment of the present invention, the variation, as a function of the environment, of at least some of the parameters of the 3D elements is a continuous variation in terms of average value. These parameters having a random value with a pre-selected variance.

In accordance with an embodiment of the present invention, the distribution density of the elements is varied from predetermined profiles in order to generate element patterns.

In accordance with an embodiment of the present invention, the 3D elements are given an orientation included in a group comprising: the vertical orientation, the orientation along the normal to the terrain and a predetermined or random orientation between the vertical orientation and an orientation normal to the terrain.

In accordance with an embodiment of the present invention, an axis is assigned to each 3D element, and the orientation of the 3D elements around their axis is varied in a random or deterministic fashion as a function of the environment. In accordance with an aspect of the present invention, the variation of the orientation of the 3D elements around their axis can be limited between predetermined angle values. Thereby enabling the software product of the present invention to generate directional effects, for example linked to the wind blowing in a given direction.

In accordance with an embodiment of the present invention, 3D elements of a given nature are generated by varying parameters of these elements in a deterministic or pseudo-random fashion, the parameters being included in the group comprising the geometry, the size, the orientation, and the color. For example, in the case of vegetation, a wide diversity of plants of the same nature is obtained, which corresponds to the diversity in nature, in that it varies as a function of the environment.

In accordance with an embodiment of the present invention, 3D elements of different natures are made to coexist on a terrain, and/or 3D elements of a given nature are made to coexist with objects or environments on the terrain. The rules for the coexistence of 3D elements of different natures and/or of 3D elements and objects or environments on the terrain are set so that the parameters of the 3D elements depend on the positions of the 3D elements relative to the other 3D elements or relative to the objects or environments.

Coexistence can be favorable or unfavorable to the 3D elements. An example of an unfavorable coexistence is the presence of stone which is unfavorable to vegetation; in proximity to this stone, the vegetation will be less dense and its color will be lighter (more yellow). An example of a favorable coexistence is the presence of ferns on certain trees or sheep where the environment is grassy.

Preferably, the objects or environments on the terrain are generated prior to distributing the 3D elements on this terrain, and the presence of an object or environment is determined by dividing the surface into elementary surfaces and detecting the presence of objects or environments in each of the elementary surfaces.

In accordance with an aspect of the present invention, the software product can make the 3D elements of different natures coexist, and assign a different probability of appearance to the 3D elements of different natures. Thus, when several 3D elements coexist, such as buildings, a much higher probability is assigned to low buildings than to high-rises, for example.

In accordance with an embodiment of the present invention, for each distribution density value of the 3D elements on the terrain, either an even distribution or a random or pseudo-random distribution of these 3D elements is imposed.

In accordance with an embodiment of the present invention, the distribution of the elements is random or pseudo-random and the terrain is divided into zones. The number of 3D elements in each zone is determined so as to conform to the average density value in this zone. In accordance with an aspect of the present invention, a pseudo-random distribution of the 3D elements is imposed such that this distribution remains the same for a terrain of the same type, for 3D elements of the same nature having the same parameters, and in the same environment.

In accordance with an embodiment of the present invention, the distributed 3D elements are controllable through an interface of the same type as the interface used to control the appearance of a surface.

In accordance with an embodiment of the present invention, the 3D elements are distributed only on the parts of the terrain where the 3D elements can be visible on the viewable landscape that appears first. In accordance with an aspect of the present invention, the 3D elements are distributed on the other parts of the terrain immediately before they are likely to become visible. This saves time and computing power. In order to ensure the consistency of the representation, the present invention can distribute 3D elements on a fraction of the non-visible parts of the terrain that are located in proximity to the visible parts.

In order to determine the visibility of 3D elements, the present invention can divide the surface of the terrain into parcels or elementary surfaces, and assign each parcel a volume that encompasses it. This volume depends on the size of the elements actually or potentially present on the parcel. The visibility of the 3D elements of each parcel depends on the visibility of this volume. In accordance with an aspect of the present invention, the surface of each parcel can be chosen so that it occupies a more or less constant surface area in the final image; for example, the surface area of the parcels decreases with their distance from the foreground of the 3D landscape.

In accordance with an embodiment of the present invention, when 3D elements of non-visible parts of the terrain are likely to have effects on the visible parts of the terrain, these 3D elements are distributed on these non-visible parts of the terrain. For example, the shadows of invisible 3D elements may be visible. Likewise, the effects of the reflection or refraction of invisible 3D elements may be visible.

In accordance with an embodiment, in order to determine the visible parts of a 3D landscape, rays are generated in the viewing direction, and the 3D elements or objects or parts of the landscape hit by this ray are determined. The terrain is divided into zones, each zone including a small number of elements or objects. In each zone of the terrain, the minimum altitude and the maximum altitude of the 3D elements, objects and/or of the terrain are stored. The altitude of each exploratory ray is compared to the minimum and maximum altitudes in each zone, the zone being invisible if no point of the ray in the zone falls between the minimum altitude and the maximum altitude of the zone.

The present method differs from the known “Octree” method wherein the exploration is performed inside cubes, in that it takes advantage of the fact there is a terrain, and hence a surface, which simplifies the exploration. It takes less time to navigate the tree structure of the zones, and additionally it requires less memory capacity.

In accordance with an embodiment of the present invention, a method for generating 3D landscapes, comprising the steps of selecting a plurality of 3D elements from a library of vegetative elements; and either distributing the 3D elements on a terrain so that parameters of the 3D elements depend on an environment of the 3D elements or distributing the 3D element on a terrain with a variable distribution density such that the parameters of the 3D elements depend on the variable distribution density. The parameters comprises nature of the 3D elements, distribution density of the 3D elements, size of the 3D elements, orientation of the 3D elements, color of the 3D elements and shape of the 3D elements. The environment comprises at least one of the following: an altitude of the terrain, a slope of the terrain, a position of the 3D elements relative to objects or other 3D elements on the terrain.

The present invention also concerns a software product that implements the method defined above.

In accordance with an embodiment of the present invention, a computer readable medium comprises code for generating 3D landscapes. The code comprises instructions for selecting a plurality of 3D elements from a library of vegetative elements; and either distributing the 3D elements on a terrain so that parameters of the 3D elements depend on an environment of the 3D elements or distributing the 3D element on a terrain with a variable distribution density such that the parameters of the 3D elements depend on the variable distribution density. The parameters comprises nature of the 3D elements, distribution density of the 3D elements, size of the 3D elements, orientation of the 3D elements, color of the 3D elements and shape of the 3D elements. The environment comprises at least one of the following: an altitude of the terrain, a slope of the terrain, a position of the 3D elements relative to objects or other 3D elements on the terrain.

In accordance with an embodiment of the present invention, a computer system for generating 3D landscapes comprises a module for selecting a plurality of 3D elements from a library of vegetative elements, and a distributing module for distributing either a) the 3D elements on a terrain so that parameters of the 3D elements depend on an environment of the 3D elements or b) the 3D element on a terrain with a variable distribution density such that the parameters of the 3D elements depend on the variable distribution density. The parameters comprises nature of the 3D elements, distribution density of the 3D elements, size of the 3D elements, orientation of the 3D elements, color of the 3D elements and shape of the 3D elements. The environment comprises at least one of the following: an altitude of the terrain, a slope of the terrain, a position of the 3D elements relative to objects or other 3D elements on the terrain.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIGS. 1-7 are schematic diagrams of control screens or interfaces of a software product in accordance with an embodiment of the present invention;

FIG. 8 shows an exemplary 3D landscape obtained with the software product in accordance with an embodiment of the present invention;

FIGS. 9a, 9b, 10 and 11 are diagrams illustrating features of the present invention.

### DETAILED DESCRIPTION OF THE EMBODIMENTS

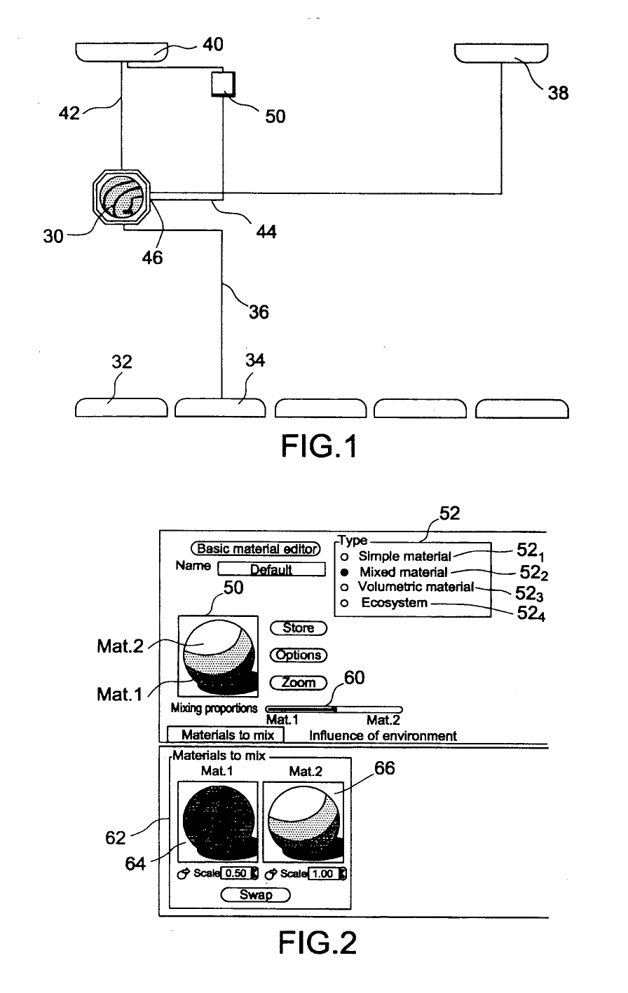

Turning now to FIG. 1, there is illustrated a screen or interface for setting up functions in accordance with an exemplary embodiment of the present invention, i.e., modifications of the data of a surface 30 (terrain) as a function of the environment of this surface. The surface 30 is represented by a sphere. Below this representation of the surface are locations representing surface modification properties such as colors 32, projections 34, etc. In order to give the surface the corresponding property, a link 36 is established with the element 30 using a device such as a “mouse” or other comparable input device.

Above the surface 30, the interface comprises a plurality of headings representing the environment of the surface, i.e., position, altitude, slope and orientation, and other parameters such as angle of incidence, depth, and distance from other objects. In the example, a link is established using the mouse or other comparable input device between the surface 30 and the orientation 38 of the surface, as well as with the position 40 (link 42).

The source of the noise, modification or disturbance of the surface is established through a link 44 between a point 46 of the surface 30 and the position heading 40. The origin of the disturbance is represented by a block 50.

In accordance with an exemplary embodiment of the present invention, FIG. 2 represents another interface for controlling the mixing of materials. An element 50 of the screen represents the surface in the form of a sphere with a representation of the materials to be mixed. In this example, the mixed materials are stone and snow.

A “type” heading 52 enables the operator or user of the software product in accordance with an embodiment of the present invention to choose the appearance of the surface, with a sub-heading with 52₁ for simple materials, a sub-heading 52₂ (checked in FIG. 2) for mixed materials, a sub-heading 52₃ for volumetric materials such as clouds, and a sub-heading 52₄ for distributed 3D elements, referred to herein as “ecosystem.”

In accordance with an embodiment of the present invention, a slider bar or cursor bar 60 can be used by the operator or user to control the proportions of material 1 and material 2, the material 1 in this case being stone and the material 2 being snow. Although the materials are mixed in equal parts in this example, the materials can be mixed in any desired proportion.

Under a size heading 62 in FIG. 2, the materials I and 2 are represented separately (64 and 66), with the possibility of choosing a scale for the representation of the materials, i.e., the size of the patterns representing these materials if they are not continuous.

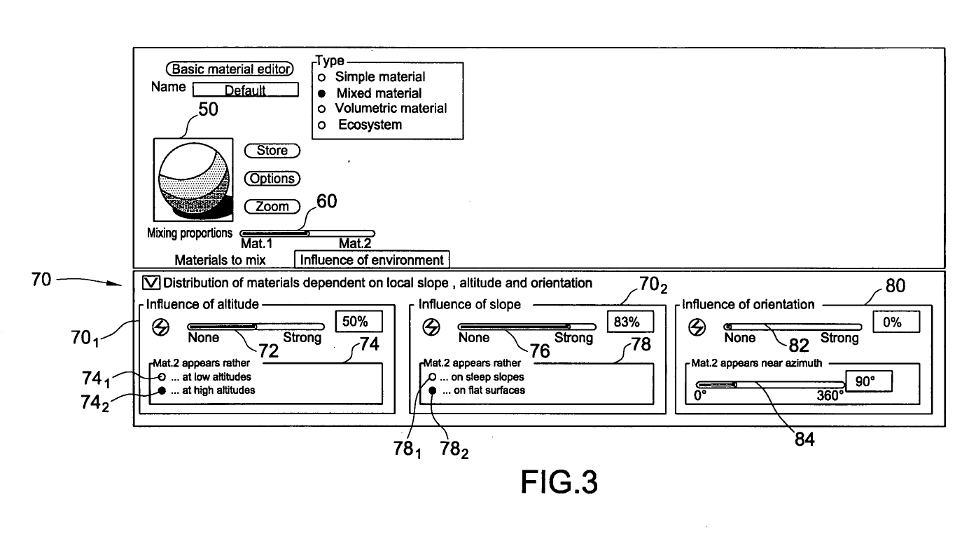

In accordance with an exemplary embodiment of the present invention as shown in FIG. 3, which corresponds to the one represented in FIG. 2, an environment heading 70 is provided for the distribution of the materials as a function of the environment of the terrain, i.e., as a function of the altitude, slope and orientation of the terrain. In this example, the material 2 is snow. In the altitude sub-heading 70₁ for the influence of altitude, an influence of the altitude of 50% has been indicated by means of a slider bar 72. In addition, an altitude appearance heading 74 can be used to determine whether the material 2 appears more at high altitudes than at low altitudes. In FIG. 3, the sub-heading 74₁ for high altitudes has been checked.

With the slope sub-heading 70₂, the influence of the slope can be adjusted. A slider bar 76 can be used to set the influence of the slope on the material 2 to 83% as shown in FIG. 3. Moreover, a slope appearance heading 78 includes two elements to check: either (78₁) the material appears on slopes, or the material preferably appears on flat surfaces (78₂). In FIG. 3, the heading 78₂ that has been checked.

Finally, an orientation heading 80 relates to the influence of the orientation of the terrain on the material 2, with a slider bar 82 indicating a zero influence of the orientation in FIG. 3, and a slider bar 84 indicating the preferred orientation of the appearance of the material relative to the azimuth.

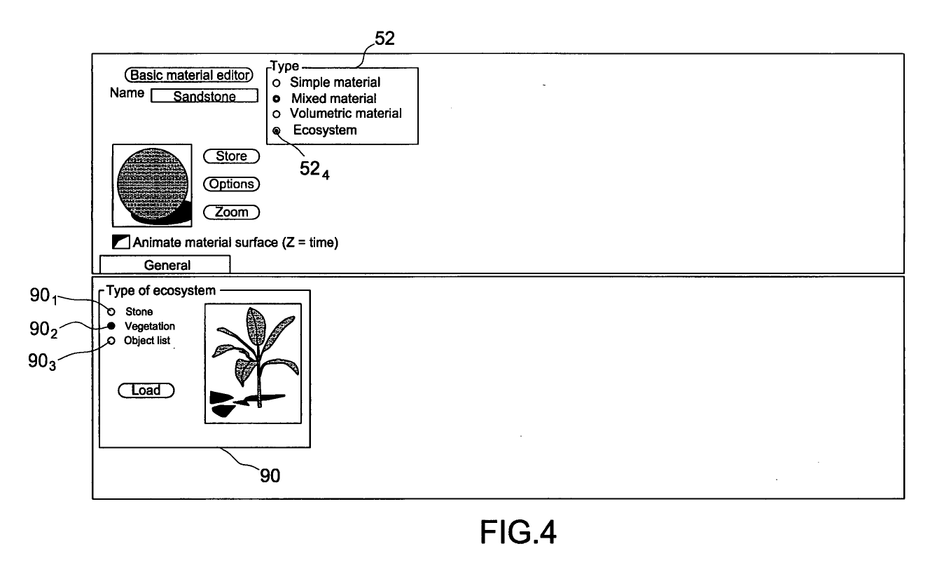

Turning now to FIG. 4, in accordance with an exemplary embodiment of the present invention, there is illustrated an ecosystem screen or interface, i.e., when an ecosystem is chosen by checking the sub-heading 52₄. For example, an ecosystem is a set of 3D elements distributed on the surface. The ecosystem interface comprises an ecosystem heading 90 for choosing the type of ecosystem. In this exemplary embodiment, three types of ecosystem are shown in FIG. 4: a type 90₁ for stone, a type 90₂ for vegetation, and a type 90₃ for other objects. The vegetation selection (i.e., when type 90₂ is checked) causes the appearance of a library of plants and trees in another interface (not shown) from which the operator or user can choose the vegetation to cover the surface. In the case of an ecosystem based on plants or stone, the elements placed on the surface of the terrain are constructed by the software product of the present invention so as to represent a diversity of samples of the type selected.

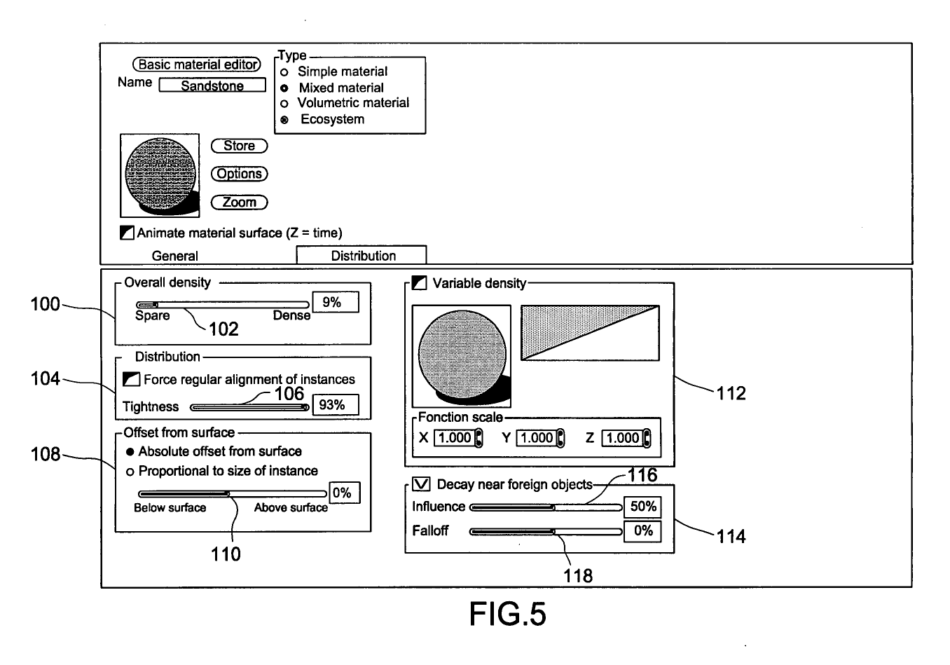

FIG. 5 shows the ecosystem interface for the distribution of 3D elements in accordance with an exemplary embodiment of the present invention with an overall density heading 100 showing the overall distribution density of the 3D elements. In this example, the overall density distribution has been set at the value of 9% by means of a slider bar 102. A distribution heading 104 of the present invention can be used to adjust the precision or quality of the distribution by means of a slider bar 106.

An offset heading 108 of the present invention in FIG. 5 can be used to choose the distance relative to the surface at each point using a slider bar 110. This offset distance can be negative or positive (i.e., below the surface or above the surface). In the case of plants, the distance will be zero since the plant grows from the surface. For elements that are partially embedded in the terrain, a negative value is chosen.

A variable density heading 112 of the present invention in FIG. 5 can be used to vary the density of the 3D elements as a function of position, i.e., as a function of the X, Y and Z coordinates and other environmental parameters such as the altitude, the slope, etc. Finally, a decay heading 114 relates to a reduction in density in the vicinity of foreign objects such as rocks. To this end, the decay heading 114 includes a slider bar 116 for the influence of a foreign object and a slider bar 118 for controlling the falloff profile. More precisely, the slider bar 116 can be used to indicate the distance from the foreign object at which the density of the vegetation begins to decrease, and the slider bar 118 can be used to determine the rule for the variation in density. In the example, this variation rule is linear.

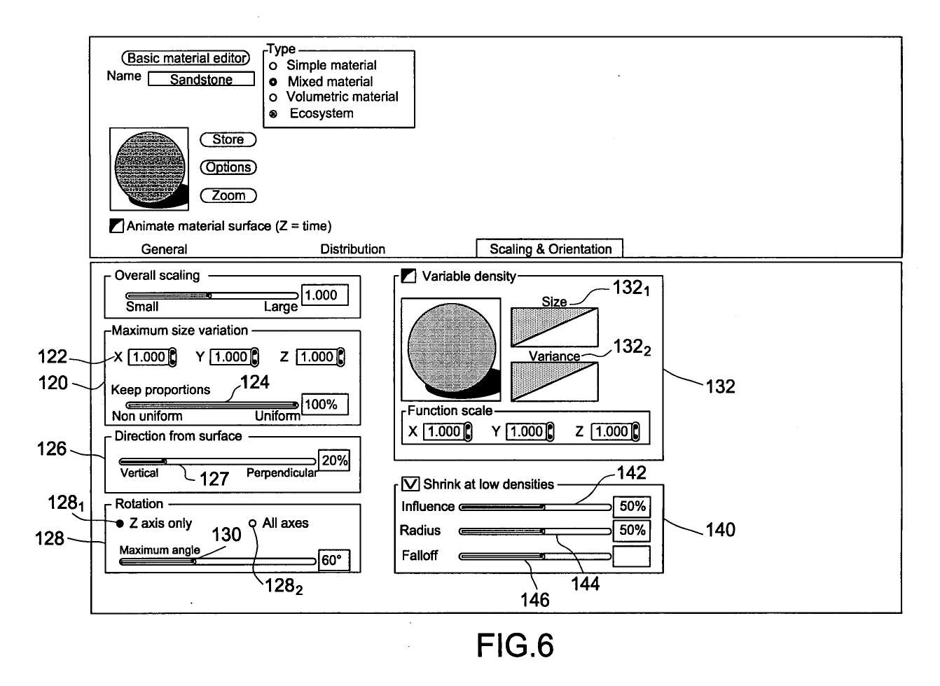

In the interface represented in FIG. 6, in accordance with an exemplary embodiment of the present invention, the proportions and variations of the 3D elements are adjustable by means of a variation header 120, which deals with the maximum size variation. The maximum size variation is determined by the X, Y and Z coordinates (sub-heading 122). A slider bar 124 can be used to determine whether the proportions of the 3D elements should be maintained when sizes are varied. In other words, if the cursor of the slider bar 124 is at 100%, all of the 3D elements will retain the same proportions.

A direction heading 126 of the present invention in FIG. 6 indicates the direction of the 3D elements relative to the surface with a slider bar 127. When the cursor is to the left, the 3D elements are vertical, whereas when the cursor is to the right, the 3D elements are perpendicular to the surface.

A rotation heading 128 of the present invention in FIG. 6 indicates the possibility of rotating the 3D elements around an axis or several axes. In this case, the heading 128₁ indicating the Z axis (i.e., the vertical axis of the 3D element) has been checked. The sub-heading 128₂ links to the possibility of rotating around all axes. The rotation heading 128 also includes a slider bar 130 indicating the maximum angle of rotation around the axis or axes. In the example shown in FIG. 6, the maximum angle around the Z axis is 60°.

A variable density heading 132 of the present invention in FIG. 6 can be used to adjust the size 132₁ and its variance 132₂. A low density heading 140 of the present invention in FIG. 6 can be used to adjust the size as a function of the density. More precisely, the low density heading 140 indicates a reduction in size if the density decreases. Thus, the low density heading 140 includes a first slider bar 142 indicating the influence of the density on the size. A slider bar 144 can be used to adjust the density level at which the size begins to decrease, and a slider bar 146 can be used to adjust the variation profile of the size which, in the example, is linear.

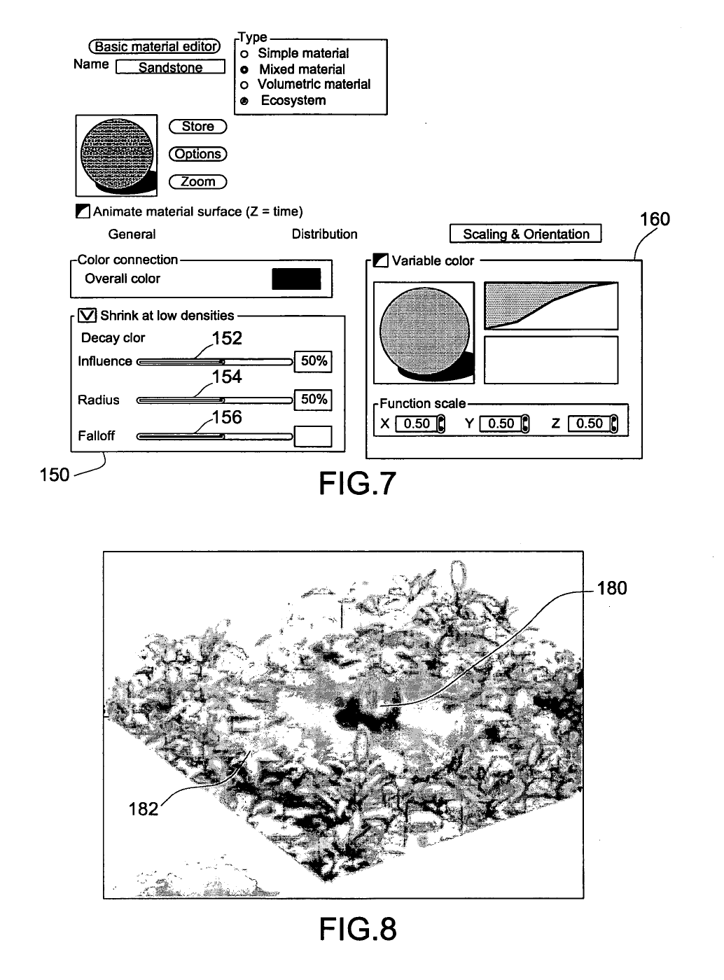

In the interface represented in FIG. 7, in accordance with an exemplary embodiment of the present invention, the rules for varying the color of the 3D elements are indicated. The interface comprises a density heading 150 indicating the rule for varying the color for low 3D element densities. A slider bar 152 can be used to control the influence of the density on the color; a slider bar 154 is provided for determining the threshold below which a color variation is applied, and a slider bar 156 is provided for determining the variation profile of the color.

A color heading 160 of the present invention in FIG. 7 is provided for adjusting the color variation as a function of the position or other parameters (altitude, orientation, slope, etc.).

Turning now to FIG. 8, there is illustrated a part of the landscape in accordance with an exemplary embodiment of the present invention showing the influence of a foreign object 180, constituted by a rock, on a plant population. All of the plants 182 are of the same nature. However, due to the adjustments of the parameters, the 3D elements have different geometries and sizes as well as different orientations. Moreover, the size of the plant elements is such that it is smaller in proximity to the rock 180, and the color is lighter in proximity to the rock 180.

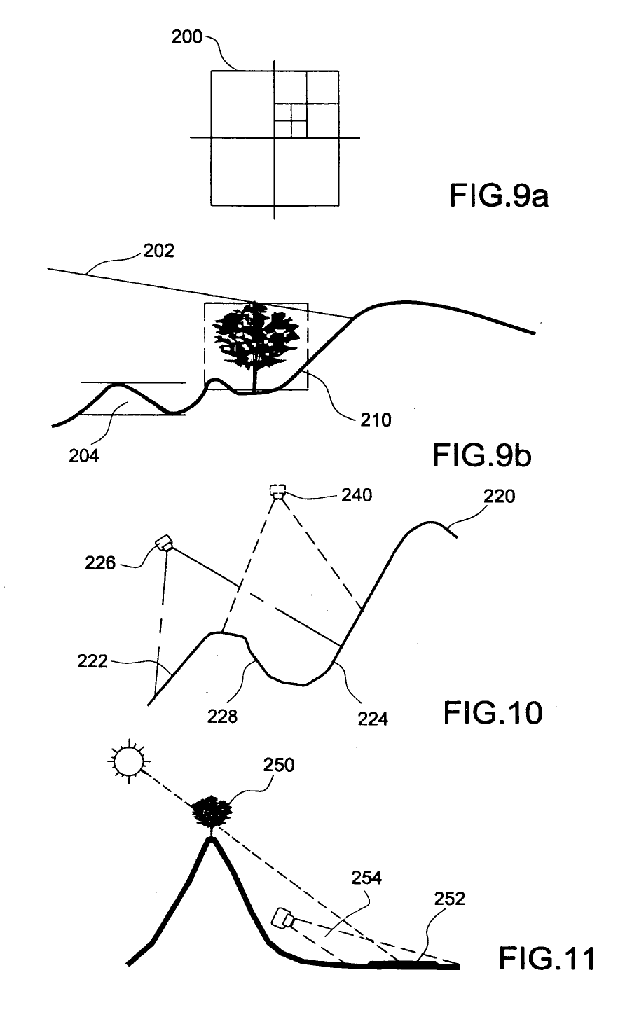

In accordance with an exemplary embodiment of the present invention, a feature for simplifying the computations for creating 3D landscapes while limiting the memory capacity required is described in conjunction with FIGS. 9a and 9b. Before describing this exemplary feature of the present invention in detail, the so-called “Octree” technique used to calculate landscape representations from a given viewing angle is summarized. We take a set of rays having directions corresponding to those of the luminous rays entering into the optical system of a virtual camera, along the desired viewing angle, and determine the objects of the scene that intersect with these rays. First, the cube is divided into 8 equal parts so as to reduce the number of objects located in each cube, and the subdivision stops when the number of objects in a cube is small. Thus, the finest subdivision appears where the density of objects is highest. To reconstruct a scene, it is therefore necessary to read the contents of the various cubes of the subdivision, which takes time and uses up memory space. To reduce this time, the present invention takes advantage of the fact that a landscape is constructed on a surface and is not distributed throughout the space.

In accordance with an embodiment of the present, the terrain is therefore divided into squares (FIG. 9a) or other shapes which form elementary surfaces that are subdivided according to the same principle as the Octree described herein, except that the subdivision is done in 2D only, instead of 3D. Each square is assigned a minimum altitude and a maximum altitude corresponding to the minimum and maximum altitude of 3D elements present in the corresponding elementary zone. Under these conditions, the ray 202 (FIG. 9b) will only encounter one of the 3D elements if it is present between the minima and maxima altitudes inside the elementary zone. Thus as shown in FIG. 9b, the ray 202 is located above the maximum altitude in the zone 204, whereas the ray 202 reaches an altitude between the minimum value and the maximum value in the zone 210. Thus, a simpler subdivision with fewer elementary cells than in the Octree process is obtained with the present invention, and the criterion for determining whether or not a ray encounters an object in a zone or cell is simpler and thus more economical in terms of computing power.

In accordance with an embodiment of the present invention, the landscape is “populated,” i.e., covered with 3D elements, only for the parts that are visible. For example, as represented in FIG. 10, only the parts 222, 224 that are seen by a virtual camera 226 need to be populated in the landscape 220. On the other hand, the part 228, whose slope is such that it is not seen by the camera 226, does not need to be populated with 3D elements. The same is true of the parts 230 outside the field of vision of the virtual camera 226. This saves on memory space and computing time.

The population of the other zones takes place immediately before they enter into a field of vision like that of the virtual camera 240 or immediately before a ray is likely to touch one of the 3D elements of the not-yet-populated zone. For example, in FIG. 11, an element 250 located outside the field of vision can have an influence through its shadow 252 in the field of vision 254. It should be noted that the term ray is used in the same sense as in the so called “ray tracing” technique.

In order to prevent any problem of seeing the edges between zones, it is possible to populate part of the non-visible zones near the edges of visibility.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described herein. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for generating 3D landscapes, comprising the steps of:
selecting a plurality of 3D elements from a library of vegetative elements; and
either distributing said 3D elements on a terrain so that parameters of said 3D elements depend on an environment of said 3D elements or distributing said 3D element on a terrain with a variable distribution density such that said parameters of said 3D elements depend on said variable distribution density; and
wherein said parameters comprises nature of said 3D elements, distribution density of said 3D elements, size of said 3D elements, orientation of said 3D elements, color of said 3D elements and shape of said 3D elements; and
wherein said environment comprises at least one of the following: an altitude of said terrain, a slope of said terrain, a position of said 3D elements relative to objects or other 3D elements on said terrain.

2. The method of claim 1, further comprising the step of varying at least one of said parameters of said 3D elements as a function of said environment such that the variation is a continuous variation in terms of average value; and wherein said at least one of parameters has a random value with a pre-selected variance.

3. The method of claim 1, further comprising the step of varying said distribution density of said elements from predetermined profiles to create element patterns.

4. The method of claim 1, further comprising the step of orienting said 3D elements in one of the following orientations: a vertical orientation, an orientation along the normal to said terrain, and a predetermined or random orientation between said vertical orientation and said orientation normal to said terrain.

5. The method of claim 1, further comprising the steps of assigning an axis to each 3D element and varying said orientation of said each 3D element around said axis in a random or deterministic fashion as a function of said environment.

6. The method of claim 5, further comprising the step of limiting the variation of said orientation of said each 3D element around said axis between predetermined angle values.

7. The method of claim 1, further comprising the step of generating the nature of said 3D elements by varying said parameters of said 3D elements in a deterministic or pseudo-random fashion, said parameters comprising geometry, size, orientation and color of said 3D elements.

8. The method of claim 1, further comprising the steps of making different natures of said 3D elements coexist on said terrain or making 3D elements of a given nature coexist with objects or environments on said terrain; and setting the rules for the coexistence so that said parameters of said 3D elements depend on the positions of said 3D elements relative to other 3D elements or relative to the objects or environments on said terrain0.

9. The method of claim 8, further comprising the steps of generating the objects or environments on said terrain prior to distributing said 3D elements on said terrain; and determining the presence of an object or environment by dividing the surface of said terrain into elementary surfaces and detecting the presence of objects or environments in each of said elementary surfaces.

10. The method of claim 8, further comprising the step of assigning a different probability of appearance to said 3D elements of different natures.

11. The method of claim 1, further comprising the step of imposing either an even, random or pseudo-random distribution of said 3D elements for each distribution density value of said 3D elements on said terrain.

12. The method of claim 11, wherein the distribution of said 3D elements is random or pseudo-random; and further comprising the step of dividing said terrain into zones, the number of said 3D elements in each zone being determined so as to conform to the average density value in said each zone.

13. The method claim 12, further comprising the step of imposing a pseudo-random distribution of said 3D elements such that said pseudo-random distribution remains the same for a terrain of the same type, and 3D elements of the same nature having the same parameters and in the same environment.

14. The method of claim 1, further comprising the step of controlling said distributed 3D elements through an interface, said interface being of the same type as an interface for controlling the appearance of a surface of said terrain.

15. The method of claim 1, further comprising the steps of distributing said 3D elements only on the parts of said terrain where said 3D elements are visible in a viewable 3D landscape first; and distributing said 3D elements on the other parts of said terrain immediately before they are likely to become visible in said viewable 3D landscape.

16. The method of claim 15, further comprising the step of distribution said 3D elements on a fraction of non-visible parts of said terrain that are located in proximity to said visible parts of said terrain to ensure consistency of the representation of said 3D landscape.

17. The method of claim 15, further comprising the steps of dividing the surface of said terrain into parcels or elementary surfaces to determine the visibility of said 3D elements; and assigning each parcel a volume that encompasses said each parcel; and wherein said volume depends on the size of said 3D elements actually or potentially present on said parcel; and wherein the visibility of said 3D elements of each parcel depends on the visibility of said volume.

18. The method of claim 17, further comprising the step of selecting the surface of each parcel so that said selected surface occupies a more or less constant surface area in the final image of said 3D landscape.

19. The method of claim 18, further comprising the step of decreasing the surface area of said each parcel based on said each parcel's distance from the foreground of said 3D landscape.

20. The method of claim 15, further comprising the step of distributing said 3D elements on non-visible parts of said terrain if it is determined that said 3D elements on non-visible parts of said terrain are likely to have effects on said visible parts of said terrain.

21. The method of claim 1, further comprising the steps of:
generating rays in a viewing direction;
determining said 3D elements, objects or parts of a 3D landscape hit by said rays to determine visible parts of said 3D landscape;
dividing said terrain into zones, each zone comprising a small number of elements or objects;
storing the minimum altitude and the maximum altitude of said 3D elements, objects or said terrain for said each zone of said terrain; and
comparing the altitude of each exploratory ray to the minimum and maximum altitudes in each zone, a zone being invisible if no point of said each exploratory ray in said zone falls between the minimum altitude and the maximum altitude of said zone.

22. A computer system for generating 3D landscapes, comprising:
a module for selecting a plurality of 3D elements from a library of vegetative elements;
a distributing module for distributing either a) said 3D elements on a terrain so that parameters of said 3D elements depend on an environment of said 3D elements or b) said 3D element on a terrain with a variable distribution density such that said parameters of said 3D elements depend on said variable distribution density; and
wherein said parameters comprises nature of said 3D elements, distribution density of said 3D elements, size of said 3D elements, orientation of said 3D elements, color of said 3D elements and shape of said 3D elements; and
wherein said environment comprises at least one of the following: an altitude of said terrain, a slope of said terrain, a position of said 3D elements relative to objects or other 3D elements on said terrain.

23. A computer readable medium comprising code for generating 3D landscapes, said code comprising instructions for:
selecting a plurality of 3D elements from a library of vegetative elements; and
either distributing said 3D elements on a terrain so that parameters of said 3D elements depend on an environment of said 3D elements or distributing said 3D element on a terrain with a variable distribution density such that said parameters of said 3D elements depend on said variable distribution density; and
wherein said parameters comprises nature of said 3D elements, distribution density of said 3D elements, size of said 3D elements, orientation of said 3D elements, color of said 3D elements and shape of said 3D elements; and
wherein said environment comprises at least one of the following: an altitude of said terrain, a slope of said terrain, a position of said 3D elements relative to objects or other 3D elements on said terrain.
